(19) United States
(12) Patent Application Publication
(10) Pub. No.: US 2021/0395112 A1
(43) Pub. Date: Dec. 23, 2021

(54) REUSABLE FUNCTIONALIZED HYDROGEL SORBENTS FOR REMOVING PERFLUOROALKYL AND POLYFLUOROALKYL SUBSTANCES FROM AQUEOUS SOLUTION

(71) Applicant: The Texas A&M University System, College Station, TX (US)

(72) Inventors: Jun Kameoka, College Station, TX (US); Po-Jung Huang, College Station, TX (US); Kung-Hui Chu, College Station, TX (US)

(73) Assignee: The Texas A&M University System, College Station, TX (US)

(21) Appl. No.: 17/297,422

(22) PCT Filed: Nov. 27, 2019
(86) PCT No.: PCT/US2019/063613

§ 371 Date: May 26, 2021

Related U.S. Application Data
(60) Provisional application No. 62/772,469, filed on Nov. 28, 2018.

(51) Int. Cl. C02F 1/28; C02F 1/58; B01J 20/28; B01J 20/26

(52) U.S. Cl. CPC C02F 1/285; C02F 1/58; C02F 2101/36; B01J 20/262; B01J 20/264; B01J 20/28047

(57) ABSTRACT

Hydrogel-based sorbents and methods for their use in collecting, concentrating, and removing environmental per- and poly-fluoroalkyl substances. In one aspect, the invention provides hydrogel-based sorbents that are effective for collecting, concentrating, and removing PFASs from an environment in which the sorbent is placed; an environment in which the sorbent is in contact with (e.g., liquid communication).

### CROSS-REFERENCE TO RELATED APPLICATION

This application claims the benefit of U.S. Application No. 62/772,469, filed Nov. 28, 2018, expressly incorporated herein by reference in its entirety.

### BACKGROUND OF THE INVENTION

Per- and poly-fluoroalkyl substances (PFASs) are groups of synthetic compounds with low surface tension and unique hydrophobic and hydrophilic characteristics. PFASs are broadly used in various industries, including paintings, clothing, electrical conductors, and polytetrafluoroethylene coatings for many decades (Butt, C. M.; Muir, D. C.; Mabury, S. A., Biotransformation pathways of fluorotelomer-based polyfluoroalkyl substances: a review. Environ. Toxicol. Chem. 2014, 33, (2), 243-67). Exposure to PFASs has been demonstrated to cause developmental effects, liver and kidney toxicity, immune effects, and cancer in animal studies. Long-chain perfluoroalkyl acids like perfluorooctanoic acid (PFOA) and perfluorooctanesulfonic acid (PFOS) are of particularly concern (EPA, Fact Sheet PFOA & PFOS Drinking Water HealthAdvisories. United States Environmental Protection Agency 2016, EPA 800-F-16-003). The United States Environmental Protection Agency (EPA) has set health advisory levels for PFOA and PFOS in drinking water at 70 ng L⁻¹ of individual or combined concentrations (Hu, X. C.; Andrews, D. Q.; Lindstrom, A. B.; Bruton, T. A.; Schaider, L. A.; Grandjean, P.; Lohmann, R.; Carignan, C. C.; Blum, A.; Balan, S. A.; Higgins, C. P.; Sunderland, E. M., Detection of Poly- and Perfluoroalkyl Substances (PFASs) in U.S. Drinking Water Linked to Industrial Sites, Military Fire Training Areas, and Wastewater Treatment Plants. Environ. Sci. Technol. Lett. 2016, 3, (10), 344-350). Due to the phase out of the long-chain PFASs (≥C₈) in 2015, short-chain PFASs such as C₆ poly-fluoroalkyl substances and a new PFAS such as GenX (2,3,3,3-tetrafluoro-2-(heptafluoropropoxy)propanoic acid) have been widely manufactured and used by industries in recent years. The shift of using different PFASs has resulted in increasing occurrences of a wide range of PFASs, particularly short-chain PFASs like perfluorobutanoic acid (PFBA) and perfluorobutyl sulfonic acid (PFBS), and GenX in the environment (Sun, M.; Arevalo, E.; Strynar, M.; Lindstrom A.; Richardson, M.; Kearns, B.; Pickett, A.; Smith, D.; Knappe, D. R. U. Legacy and Emerging Perfluoroalkyl Substances Are Important Drinking Water Contaminants in the Cape Fear River Watershed of North Carolina. Environ. Sci. Technol. Lett. 2016, 3 (12), 415-419). The State of Minnesota has issued health-based guidelines for drinking water for PFBA (C₄) and PFBS (C₄) of 7 and 2 μg L⁻¹, respectively (Health, M. D. o., PFBA and Drinking Water. 2017). GenX can induce necrosis of liver cells in male mice after exposed to GenX orally for 28 days, which is more toxic to liver than that caused by PFOA based on computational models and cellular and protein assays (Gomis, M. I.; Vestergren, R.; Borg, D.; Cousins, I. T., Comparing the toxic potency in vivo of long-chain perfluoroalkyl acids and fluorinated alternatives. Environ. Int. 2018, 113, 1-9). As such, a drinking water health advisory for GenX at a concentration of lower than 140 ng L⁻¹ has been issued by the North Carolina Department of Health and Human Services in the state of North Carolina (North Carolina Department of Health and Human Services. Questions and Answers Regarding North Carolina Department of Health and Human Services Updated Risk Assessment for GenX (Perfluoro-2-propoxypropanoic acid). July 2017). Thus, an effective treatment process to remove both legacy and emerging PFASs is warranted.

Sorption processes have shown better PFAS removals from water than other treatment processes such as coagulation/flocculation/sedimentation, filtration, and advanced oxidation. Activated carbons and ion-exchange resins are two commonly used sorbents for removing long-chain PFAS from water (Yu, Q.; Zhang, R. Q.; Deng, S. B.; Huang, J.; Yu, G., Sorption of perfluorooctane sulfonate and perfluorooctanoate on activated carbons and resin: Kinetic and isotherm study. Water Res. 2009, 43, (4), 1150-1158). Granular activated carbon (GAC) can achieve a sorption capacity of 1.1 mg g GAC⁻¹ for PFOA (Hansen, M. C.; Borresen, M. H.; Schlabach, M.; Cornelissen, G., Sorption of perfluorinated compounds from contaminated water to activated carbon. J. Soils Sedim. 2010, 10, 179-185). However, GAC or ion-exchange resin are not as effective for short-chain PFASs and GenX removal (McCleaf, P.; Englund S; Östlund A.; Lindegren K.; Wiberg, K.; Ahrens, L., Removal efficiency of multiple poly- and perfluoroalkyl substances (PFASs) in drinking water using granular activated carbon (GAC) and anion exchange (AE) column tests Water Res., 2017, 120, 77-87). High costs are common associated with the applications of these sorbents. For example, ion-exchange resins are expensive to operate despite that they are reusable (Bashir, M. J. K.; Aziz, H. A.; Yusoff, M. S., Recycling of the Exhausted Cation Exchange Resin for Stabilized Landfill Leachate Treatment. The 4th International Engineering Conference—Towards engineering of 21st century 2012). As regeneration of the spent activated carbons are inefficient and energy intensive, a large quantity of the spent activated carbons generated from PFAS treatment is commonly disposed, which resulted in high disposal cost (Sabio, E.; Gonzalez, E.; Gonzalez, J. F.; González-Garcia, C. M.; A. Ramiro, J. Gañan, Thermal regeneration of activated carbon saturated with p-nitrophenol. Carbon 2004, 42 (11), 2285-2293).

Recently, new sorbents like quaternized cotton and polyaniline nanofibers have shown high sorption capabilities for PFOA and PFOS (Xu, C. M.; Chen, H.; Jiang, F., Adsorption of perfluorooctane sulfonate (PFOS) and perfluorooctanoate (PFOA) on polyaniline nanotubes. Colloids and Surfaces A-Physicochem. Eng. Aspects 2015, 479, 60-67). Recent studies have suggested that the amino groups of the sorbents contributed the positive charge, enabling rapid sorption of PFASs anions through electrostatic attraction in 4 to 48 hours (Deng, S. B.; Zheng, Y. Q.; Xu, F. J.; Wang, B.; Huang, J.; Yu, G., Highly efficient sorption of perfluorooctane sulfonate and perfluorooctanoate on a quaternized cotton prepared by atom transfer radical polymerization. Chemical Engineering Journal 2012, 193, 154-160). However, reuse of the sorbents were not addressed and appears impractical since regeneration via solvent extraction and thermal desorption can damage the sorbent structure, decrease the surface area of fibrous sorbents, and thus compromise their sorption capacity. An alternative approach for enhancing PFAS removal from aqueous solution is to increase hydrophobic interactions between the sorbents and PFAAs. Koda et al. designed fluorinated microgel star polymers to capture PFOA/PFOS using hydrophobic interaction (Koda, Y.; Terashima, T.; Sawamoto, M., Fluorous Microgel Star Polymers: Selective Recognition and Separation of Polyfluorinated Surfactants and Compounds in Water. J. Am. Chem. Soc. 2014, 136, (44), 15742-15748). The backbone structure of star polymer is composed of hydrophilic PEG groups, which can attract PFOA/PFOS to this star polymer, while the star copolymer's core is fluorinated, which can attract PFOA/PFOS by hydrophobic interactions. However, the fluorinated microgel star polymer would not be reusable because the microgel's micelle structure would not survive the PFOA/PFOS release conditions. Additionally, star polymer exists as unstable liquid phase that makes it difficult for large scale applications.

Despite the advance in the development in materials for the PFAS removal, a need exists for new sorbents for PFAS removal with short equilibrium time, high sorption capacity, rapid regeneration, and reusability. The present seeks to fulfill this need and provides further related advantages.

### SUMMARY OF THE INVENTION

In one aspect, the invention provides hydrogel-based sorbents that are effective for collecting, concentrating, and removing PFASs from an environment in which the sorbent is placed; an environment in which the sorbent is in contact with (e.g., liquid communication). The sorbents are effective to remove one or more PFASs (e.g., PFAS mixtures) from an environment.

In one embodiment, the invention provides a sorbent for removing a perfluoroalkyl substance or a polyfluoroalkyl substance from an environment, comprising a hydrogel having poly(ethylene oxide) repeating units and multiple perfluoroalkyl groups or polyfluoroalkyl groups. In certain of these embodiment, the ratio of poly(ethylene oxide) groups to perfluoroalkyl groups or polyfluoroalkyl groups is from about 1:0.5 to about 1:3. As described herein, sorbent A is representative of these sorbents.

In another embodiment, the invention provides a sorbent for removing a perfluoroalkyl substance or a polyfluoroalkyl substance from an environment, comprising a hydrogel having poly(ethylene oxide) repeating units and multiple amine groups. In certain of these embodiment, the ratio of poly(ethylene oxide) groups to amine groups is from about 1:0.5 to about 1:2. As described herein, sorbent B is representative of these sorbents.

In a further embodiment, the invention provides a sorbent for removing a perfluoroalkyl substance or a polyfluoroalkyl substance from an environment, comprising a hydrogel having poly(ethylene oxide) repeating units and multiple perfluoroalkyl groups or polyfluoroalkyl groups and multiple amine groups. In certain of these embodiment, the ratio of poly(ethylene oxide) groups to perfluoroalkyl groups or polyfluoroalkyl groups to amine groups is from about 1:0.5:0.5 to about 1:0.5:2. As described herein, sorbent C is representative of these sorbents.

In another aspect of the invention, methods for using the sorbents to remove or collect PFASs are provided. In certain embodiments, the invention provides methods for removing a perfluoroalkyl substance or polyfluoroalkyl substance from an environment, comprising contacting an environment contaminated with one or more perfluoroalkyl substances or polyfluoroalkyl substances with a sorbent of the invention as described herein.

In a further aspect, the invention provides devices that include the sorbents of the invention. The devices are effective for removing, collecting (e.g., sampling), or concentrating a perfluoroalkyl substance or polyfluoroalkyl substance from an environment. The devices include a sorbent of the invention and a housing for receiving the sorbent and adapted to provide contact between the sorbent and the environment.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 is a schematic diagram for hydrogel sorbent synthesis via functionalization of PEGDA by soft lithography. Sorbent A and sorbent B were fabricated via fluoridation and amination using 1H,1H,2H,2H-perfluorooctyl methacrylate and [2-(methacryloyloxy)ethyl]trimethylammonium chloride, respectively. Sorbent C was fabricated via bifunctionalization by integrating fluoridation and amination.

FIG. 2 compares Fourier-transform infrared (FTIR) spectra and zeta potential of PEGDA and functionalized PEGDA: (a) PEGDA; (b) Sorbent A, (c) Sorbent B; and (d) Sorbent C. The characterized peak of PEGDA, 13FOMA and MTAC are marked in FTIR spectra. Dash line indicated the peak, ν(C—F)_{13FOMA}, ν(C—N)_{MTAC}, and ν(C—O—C)_{PEGDA}.

FIGS. 3A and 3B compare sorption % and capability of sorbents B and C for long-chain PFASs (C8: PFASs having 8 carbons) and short-chain PFASs (C4: PFASs having 4 carbons) and GenX: the sorption % of PFOA, PFBA, PFOS, PFBS, and GenX after 6 hours of incubation at room temperature (3A); and sorption capacity of sorbent B and sorbent C for PFASs (3B). The average initial PFASs concentration determined by LC/MS/MS: PFOA=103.6 mg/L, PFOS=33.3 mg/L, PFBA=106.3 mg/L, PFBS=111.5 mg/L, and GenX=63.8 mg/L.

FIG. 4 compares FTIR spectra of sorbent A before and after sorption of PFASs (a); before sorption; (b) PFOA sorption; (c) PFOS sorption; (d) PFBA sorption; (e) PFBS sorption.

FIG. 5 compares FTIR spectra of sorbent B before and after sorption of PFASs: (a) before sorption; (b) PFOA sorption; (c) PFOS sorption; (d) PFBA sorption; (e) PFBS sorption; and (f) GenX sorption.

FIG. 6 compares FTIR spectra of sorbent C before and after sorption of PFASs: (a) before sorption; (b) PFOA sorption; (c) PFOS sorption; (d) PFBA sorption; (e) PFBS sorption; and (f) GenX sorption.

FIGS. 7A-7D show positions (cm⁻¹) and mode assignments of major FTIR absorptions in peak deconvolution for sorption of PFASs for sorbent A: sorption of PFOA (7A); sorption of PFOS (7B); sorption of PFBA (7C); and sorption of PFBS (7D).

FIG. 8A-8D show positions (cm⁻¹) and mode assignments of major FTIR absorptions in peak deconvolution for sorption of PFASs for sorbent B: sorption of PFOA (8A); sorption of PFOS (8B); sorption of PFBA (8C); and sorption of PFBS (8D).

FIG. 9A-9D show positions (cm⁻¹) and mode assignments of major FTIR absorptions in peak deconvolution for sorption of PFASs for sorbent C: sorption of PFOA (9A); sorption of PFOS (9B); sorption of PFBA (9C); and sorption of PFBS (9D).

FIGS. 10A and 10B show positions (cm⁻¹) and mode assignments of major FTIR absorptions in peak deconvolution for sorption of GenX: sorption of GenX for sorbent B (10A) and sorption of GenX for sorbent C (10B).

FIG. 11 compares FTIR spectra for desorption of PFASs for sorbent A: (a) before desorption; (b) PFOA desorption; (c) PFOS desorption; (d) PFBA desorption; and (e) PFBS desorption.

FIGS. 12A and 12B compare FTIR spectra for desorption of PFASs for sorbent B (12A) and sorbent C (12B): (a) before desorption; (b) PFOA desorption; (c) PFOS desorption; (d) PFBA desorption; (e) PFBS desorption; and (f) GENX desorption.

FIG. 13 is an illustration of a representative device of the invention suitable for collecting, concentrating, and removing PFASs from an environment.

### DETAILED DESCRIPTION OF THE INVENTION

Hydrogel-based sorbents are highly hydrophilic, and thus allowed pollutants in water to easily diffuse into the hydrogels. Among many materials for manufacturing hydrogel-based sorbents, poly(ethylene glycol) diacrylate (PEGDA) is an ideal substrate not only because of its hydrophilicity of the PEG backbone but also because of the diacrylate groups offering adjustable functionalization.

In certain embodiments, the present invention provides PEGDA-based hydrogel sorbents modified through functionalization of 1H,1H,2H,2H-perfluorooctyl methacrylate (13FOMA) and [2-(methacryloyloxy)ethyl] trimethyl ammonium chloride solution (MTAC) to create hydrophobic regions and/or electrostatic attractive interaction. As described herein, the functionalization of PEGDA is classified by amination, fluoridation, and bifunctionalization. The amination of PEGDA contributes electrostatic force, while the fluoridation of PEGDA presents the hydrophobic interaction. The bifunctionalization of PEGDA integrates amination and fluoridation, which contributes electrostatic force and hydrophobic interaction simultaneously. The sorbents of the invention are effective for removing long chain fluorinated substances (e.g., PFOA and PFOS), short chain fluorinated substances (e.g., PFBA and PFBS), and perfluoroalkyl ether carboxylic acid group-containing compounds (e.g., GenX). Once PFASs have been effectively sorbed by the sorbents of the invention, the sorbents can be advantageously readily regenerated for further use.

Hydrogel-Based Sorbents

In one aspect, the invention provides hydrogel-based sorbents that are effective for collecting, concentrating, and removing PFASs from an environment in which the sorbent is placed; an environment in which the sorbent is in contact with (e.g., liquid communication). The sorbents are effective to remove one or more PFASs (e.g., PFAS mixtures) from an environment.

In one embodiment, the invention provides a sorbent for removing a perfluoroalkyl substance or a polyfluoroalkyl substance from an environment, comprising a hydrogel having poly(ethylene oxide) repeating units and multiple perfluoroalkyl groups or polyfluoroalkyl groups. In certain of these embodiment, the ratio of poly(ethylene oxide) groups to perfluoroalkyl groups or polyfluoroalkyl groups is from about 1:0.5 to about 1:3. As described herein, sorbent A is representative of these sorbents.

In another embodiment, the invention provides a sorbent for removing a perfluoroalkyl substance or a polyfluoroalkyl substance from an environment, comprising a hydrogel having poly(ethylene oxide) repeating units and multiple amine groups. In certain of these embodiment, the ratio of poly(ethylene oxide) groups to amine groups is from about 1:0.5 to about 1:2. As described herein, sorbent B is representative of these sorbents.

In a further embodiment, the invention provides a sorbent for removing a perfluoroalkyl substance or a polyfluoroalkyl substance from an environment, comprising a hydrogel having poly(ethylene oxide) repeating units and multiple perfluoroalkyl groups or polyfluoroalkyl groups and multiple amine groups. In certain of these embodiment, the ratio of poly(ethylene oxide) groups to perfluoroalkyl groups or polyfluoroalkyl groups to amine groups is from about 1:0.5:0.5 to about 1:0.5:2. As described herein, sorbent C is representative of these sorbents.

The sorbents of the invention can be prepared from polymerization of a poly(ethylene glycol) diacrylate (PEGDA) and one or more of a polymerizable perfluoroalkyl compound or polyfluoroalkyl compound, and/or a polymerizable amine compound.

In certain embodiments of the sorbents of the invention, the perfluoro- or polyfluoroalkyl group is a —CₙFₙ₊₂CF₃ group, wherein n is an integer from =3 to 11.

In certain embodiments, the sorbents of the invention include an amine group. Suitable amine groups include primary amines, secondary amines, tertiary amines, and quaternary amines. Representative amine groups include —NH₂, —NHR¹, —N(R¹)(R²), and —N⁺(R¹)(R²)(R³) groups, wherein R¹, R², and R³ are independently selected from C1-C6 alkyl groups. In certain embodiments, the amine group is a quaternary amine group (e.g., —N(CH₃)₃⁺).

In certain embodiments, the sorbents of the invention further include one or more additives to enhance their hydrophobicity. Suitable hydrophobicity-enhancing additives include materials such as fluorographene.

In certain embodiments, the sorbents of the invention further include one or more additives to enhance their mechanical strength. Representative mechanic strength-enhancing additives include calcium oxide, silica, silicon dioxide, alumina, and aluminum oxide.

In certain embodiments, the sorbents of the invention are immobilized on or in a substrate. Suitable substrates include membranes, such a polymer-based membranes (e.g., polysulfone). In certain of these embodiments, the substrate is a porous substrate. Representative porous substrates include activated carbon, biochars, chitosan, and mesoporous silica.

In certain embodiments, the sorbent of the invention is a regeneratable sorbent. As used herein, the term “regeneratable” refers to a sorbent that has been used to collect a PFAS, subsequently treated as described below to substantially release or remove the collected PFAS to provide a sorbent that is effective for further use to collect or remove a PFAS from an environment. The regenerated sorbents have a PFAS collection capacity that is substantially the same as originally synthesized sorbents of the invention.

In certain embodiments, the sorbents of the invention are prepared by dry lift-off processes, lithography, or molding.

Methods for Using the Sorbents

In another aspect of the invention, methods for using the sorbents to remove or collect PFASs are provided.

In certain embodiments, the invention provides methods for removing a perfluoroalkyl substance or polyfluoroalkyl substance from an environment, comprising contacting an environment contaminated with one or more perfluoroalkyl substances or polyfluoroalkyl substances with a sorbent of the invention as described herein. As noted above, the sorbents are effective for collecting, concentrating, and removing PFASs from an environment in which the sorbent is placed; an environment in which the sorbent is in contact with (e.g., liquid communication).

Perfluoroalkyl substances and polyfluoroalkyl substances effectively adsorbed by the sorbents of the invention include long-chain perfluoroalkyl acids and short-chain perfluoroalkyl acids. As used herein, the term “long-chain perfluoroalkyl acid” refers to a perfluoroalkyl acid having from 7 to 11 carbon atoms, and the term “short-chain perfluoroalkyl acid” refers to a perfluoroalkyl acid having from 3 to 6 carbon atoms.

Representative perfluoroalkyl substances and polyfluoroalkyl substance that are effectively adsorbed (e.g., collected and removed) by the sorbents of the invention include perfluorooctanoic acid (PFOA), perfluorooctanesulfonic acid (PFOS), perfluorobutane sulfonic acid (PFBS), perfluorobutanoic acid (PFBA), and 2,3,3,3-tetrafluoro-2-(heptafluoropropoxy)propanoic acid (GenX).

In certain embodiments, the environment that is advantageously treated is an aqueous environment. Aqueous environments subject to PFAS contamination and therefore advantageously treated with the sorbents of the invention include lakes, ponds, reservoirs, rivers, streams, groundwater, and leachate wastewater. In one embodiment, the aqueous environment is a drinking water source.

In other embodiments, the environment that is advantageously treated is a soil environment. Representative soil environments include agricultural environments (e.g., soil environments where crops are grown).

Sorbent-Containing Devices

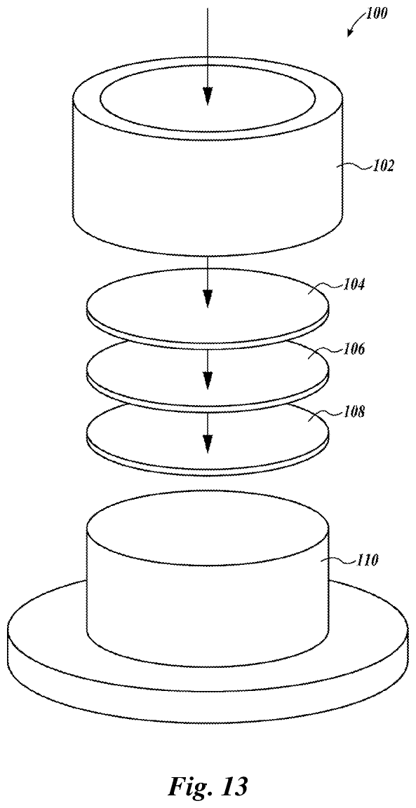

In a further aspect, the invention provides devices that include the sorbents of the invention. The devices are effective for removing, collecting (e.g., sampling), or concentrating a perfluoroalkyl substance or polyfluoroalkyl substance from an environment. The devices include a sorbent of the invention and a housing for receiving the sorbent and adapted to provide contact between the sorbent and the environment. A representative device of the invention is shown in FIG. 13.

Referring to FIG. 13, device 100 includes housing components: collar 102 and pedestal 110. Collar 102 secures sorbent 108 within the device and against pedestal 110. Collar 102 is adapted to allow liquid communication between sorbent 108 and the environment in which device 100 is placed. In certain embodiments, in addition to sorbent 108, device 100 further includes a layer of diffusive material 106 (e.g., agarose gel) adjacent sorbent 108 and filter material 104 adjacent diffusive material 106. Filter material 104 and diffusive material 106 allow PFASs from the environment to pass to sorbent 108.

The following is a description of the preparation, properties, and use of representative sorbents of the invention.

Characteristics of Sorbents A, B, and C

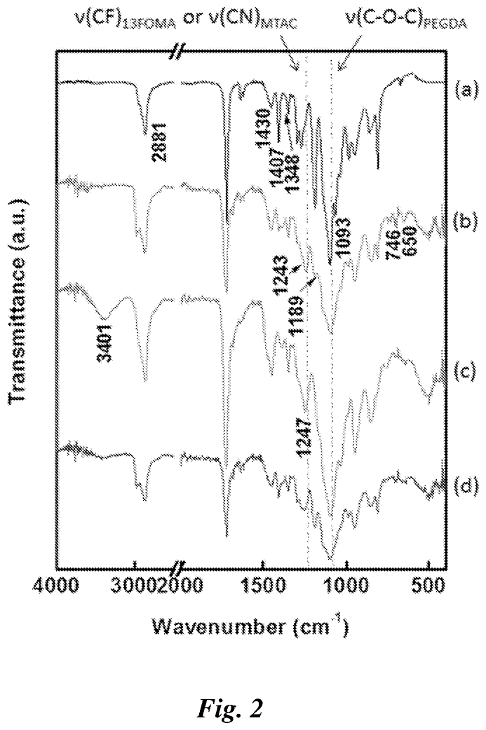

Three synthesized sorbents A, B, and C were characterized using FTIR analysis (FIG. 2). Details of characterized peaks in the FTIR spectra of PEGDA and sorbents A, B, and C are shown in Table 1.

TABLE 1
Characterized IR peaks for PEGDA, Sorbent A, Sorbent B, and Sorbent C.

| Vibration | Wavenumber (cm⁻¹) | | | |
|---|---|---|---|---|
| type | PEGDA | Sorbent A | Sorbent B | Sorbent C |
| C—H_{PEGDA} | 512 | 499 | 512 | 512 |
| C—F_{13FOMA} | | 651 | | 644 |
| C—F_{13FOMA} | | 698 | | |
| C—N_{MTAC} | | | 761 | |
| C—O—C_{PEGDA} | 852 | 848 | 850 | 858 |
| C—O—C_{PEGDA} | 948 | 950 | 946 | 952 |
| C—O—C_{PEGDA} | 1072 | 1093 | 1089 | 1101 |
| C—O_{PEGDA} | 1189 | 1178 | | |
| C—F_{13FOMA} | | 1241 | | 1251 |
| C—N_{MTAC} | | | 1247 | 1268 |
| C—O_{PEGDA} | 1347 | 1349 | 1349 | 1347 |
| C—H_{PEGDA} | 1407 | 1409 | 1407 | 1407 |
| C—H_{PEGDA} | 1450 | 1452 | 1452 | 1454 |
| N—H_{MTAC} | | | 1517 | |
| N—H_{MTAC} | | | 1635 | |
| C═C_{PEGDA} | 1637 | | | |
| C═O_{PEGDA} | 1720 | 1725 | 1725 | 1722 |
| C—H_{PEGDA} | 2867 | 2869 | 2871 | 2869 |
| C—H_{PEGDA} | | 2979 | | 2981 |
| N—H_{MTAC} | | | 3444 | 3424 |

FIG. 2a shows the FTIR spectra of PEGDA. The peaks between 2981 cm⁻¹ and 2881 cm⁻¹ were contributed by ν(C—H) from PEGDA, whereas the peaks between 1450 cm⁻¹ and 1407 cm⁻¹ were corresponding with the bending of C—H from PEGDA. In addition, the peaks between 1348 cm⁻¹ and 1093 cm⁻¹ present the ν(C—O) and ν(C—O—C) from PEGDA, respectively (Bae, M.; Divan, R.; Suthar, K. J.; Mancini, D. C.; Gemeinhart, R. A., Fabrication of Poly(ethylene glycol) Hydrogel Structures for Pharmaceutical Applications using Electron beam and Optical Lithography. J Vac Sci Technol B Microelectron Nanometer Struct Process Meas Phenom 2010, 28, (6), C6P24-C6P29). Compared to the FTIR spectra of sorbent A (FIG. 2b), the peaks between 1243, 1189, and 1141 cm⁻¹ correspond to ν(CF₂), whereas the rocking and wagging vibration of C—F were shown at the range from 746 to 650 cm⁻¹. (Gao, X. D.; Chorover, J., Adsorption of perfluorooctanoic acid and perfluorooctanesulfonic acid to iron oxide surfaces as studied by flow-through ATR-FTIR spectroscopy. Environ. Chem. 2012, 9, (2), 148-157). These peaks indicated that sorbent A has been successfully functionalized via fluorination.

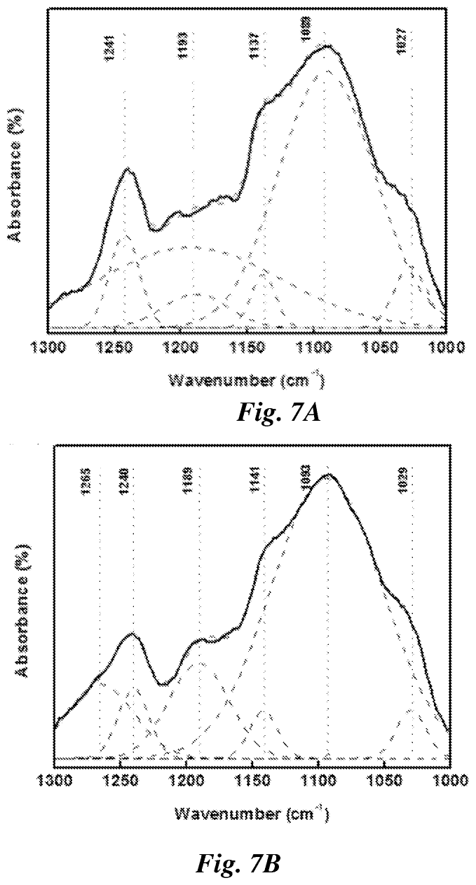

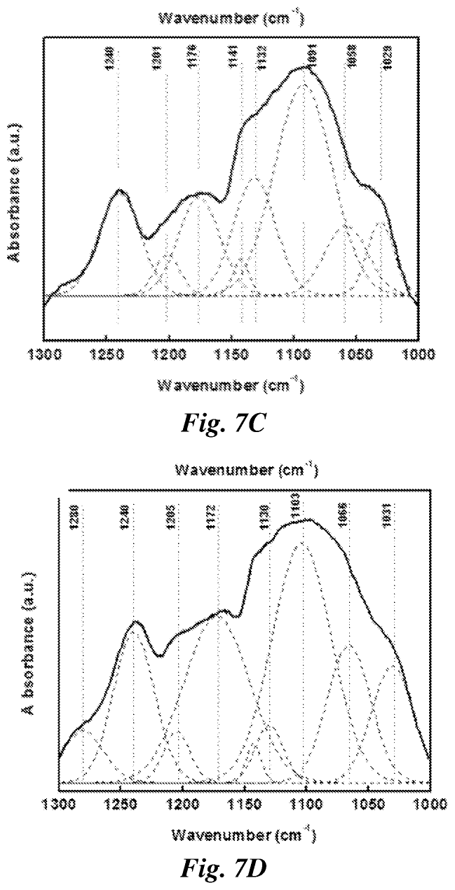

FTIR spectra of sorbent B (aminated PEGDA) is shown in FIG. 2c. Compared to those of PEGDA (FIG. 2a), the new peaks located at 1247 cm⁻¹ are assumed as ν(C—N) (Chutia, R.; Das, G., Hydrogen and halogen bonding in a concerted act of anion recognition: F-induced atmospheric CO₂ uptake by an iodophenyl functionalized simple urea receptor. Dalton Trans. 2014, 43, (41), 15628-15637). Moreover, the peaks shown in peak deconvolution, 1141 cm⁻¹ and 1485 cm⁻¹ (FIG. 7A) could be assigned as ν(C—N) and ν(—N⁺(CH₃)₃), respectively (Morales, D. V.; Rivas, B. L.; Gonzalez, M., synthesis and characterization of poly([(2-methacryloyloxy) ethyl]) trimethylamonnium chloride) resin with removal properties for vanadium(V) and molybdenum(VI). J. Chilean Chem. Soc. 2016, 61, (4), 3295-3303). The FTIR spectra of sorbent C, which is bifunctionalized, is shown in FIG. 2d. The characterized peaks for C—F and C—N were recognized in the FTIR spectra and the locations of these peaks were similar to those presence in the FTIR spectra of sorbent A and sorbent B. These results indicate that PEGDA has been successfully functionalized with 13FOMA, MTAC, and both via photo-crosslinking.

Zeta potential of PEGDA and sorbents plays a crucial role in determining the sorption capability toward PFASs. Table 2 shows the zeta potential of PEGDA and sorbents A, B, and C ranging from negative to positive.

TABLE 2
Zeta potential of PEGDA and Sorbents A, B, and C.

| | PEGDA | Sorbent A | Sorbent B | Sorbent C |
|---|---|---|---|---|
| Zeta potential | −25.4 ± 1.6 | −27.1 ± 0.4 | 39.0 ± 1.6 | 31.4 ± 0.6 |
| (mV) | | | | |

Sorbent A has a negative zeta potential of −27.1±0.4 mV, which is contributed not only from the backbone of PEGDA (−25.4±1.6 mV) but also from the fluorine of 13FOMA (Johnson, R. L.; Anschutz, A. J.; Smolen, J. M.; Simcik, M. F.; Penn, R. L., The adsorption of perfluorooctane sulfonate onto sand, clay, and iron oxide surfaces. J. Chem. Eng. Data 2007, 52, (4), 1165-1170). The zeta potential of sorbent B is positive (39.0±1.6 mV) contributed from the ammonium of MTAC. The zeta potential of sorbent C is also positive (31.4±0.6 mV) due to the combination of the negative charge of 13FOMA and the positive charge of MTAC. Accordingly, the zeta potential of sorbent C is less positive than that of the sorbent B.

PFAS Sorption by Sorbents A, B, and C

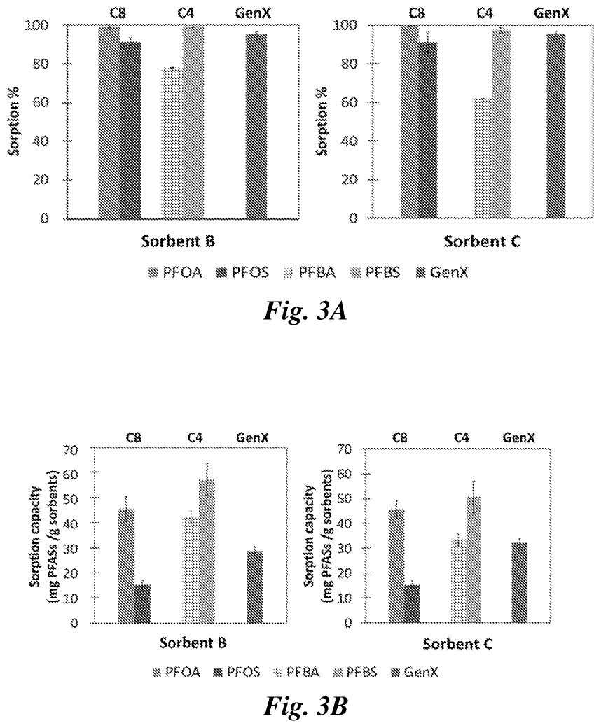

The three sorbents showed different sorption abilities, with respect to PFAS removal (%) and sorption capacity (mass of PFAS/mass of sorbent), toward these model PFASs (FIGS. 3A and 3B, Table 3).

TABLE 3
Sorption capacity of PEGDA and Sorbents A, B, and C for PFOA, PFBA,
PFOS, PFBS and Gen X (μmol/g).

| | PFOA | PFOS | PFBA | PFBS | Gen X |
|---|---|---|---|---|---|
| PEGDA* | 0 | 0 | ND | ND | ND |
| Sorbent A | 21.3 ± 0.2 | 2.2 ± 0.4 | 24.0 ± 7.1 | 0 | 0 |
| Sorbent B | 109.9 ± 8.5 | 30.4 ± 0.4 | 199.5 ± 10.8 | 190.6 ± 21.0 | 86.7 ± 5.1 |
| Sorbent C | 110.6 ± 9.7 | 30.4 ± 2.2 | 158.0 ± 0.5 | 168.9 ± 10.7 | 98.7 ± 3.9 |

*Experimental conditions for PFOA and PFOS with the PEGDA were different with the other experiments: initial concentration of PFOA or PFOS, 1 mg/L; PEGDA as a polymer: 30 mg, sorption duration: 12 hours.

PFAS removal ratio, calculated based the changes of PFAS concentration in liquid before and after incubation with sorbents divided by initial PFAS concentration in the solution, was shown in FIG. 3A. PFAS sorption capacity, defined as the amount of PFAS sorbed per the amount of sorbent (μmol/g), was calculated and shown in FIG. 3B. PEGDA showed no sorption capacity toward PFOA and PFOS.

While sorbent A can sorb low levels of PFOA, PFOS, and PFBA in 6 hours (less than 10%), sorbent A was unable to sorb PFBS and GenX. Sorbents B and C showed improved sorption abilities toward all five PFASs tested in this study (FIGS. 3A and 3B), compared to sorbent A. Sorbent B was able to completely (100%) sorb PFOA and PFBS within 6 hours, and 91% and 78% for PFOS and PFBA, respectively (FIG. 3A). Sorbent C also showed excellent PFAS removal toward PFOA and PFBS. However, sorbent C showed a less PFAS removal for PFBA (62%) than those observed for sorbent B. Both sorbents B and C showed greater than 95% of removal toward GenX.

The sorption capacity of sorbent B and sorbent C for PFOA were estimated to be greater than 109.8 and 110.0 μmol g sorbents⁻¹ (μmol/g sorbent), respectively. The PFOA sorption capacities by sorbents B and C are approximately 5 times higher than that by sorbent A (20.0 μmol g sorbents⁻¹). Compared to sorbent C, sorbent B showed a slightly higher sorption capability short-chain PFAAs, PFBA, and PFBS. However, higher GenX sorption capacities of sorbent C than those of sorbent B suggested that hydrophobic force play an important role in the sorption of long-chain PFASs. The sorption capacities for GenX by sorbent B and sorbent C are 86.7±5.1 and 98.7±3.9 μmol g sorbent⁻¹, respectively.

The differences in sorption ability of these three sorbents toward the five PFASs can be explained by the chemical properties of these PFASs and the zeta potentials of these sorbents. PFAAs, consisting of fluoroalkane and carboxylic acid or sulfonic acid, are commonly present with negative charge, and the hydrophobicity of PFAAs decrease as the chain length decreases. For GenX, composing of short chain of fluoroalkyl ether and carboxylic acid, also usually provide negative charge and hydrophobicity. Thus, hydrophobic interaction and electrostatic force are considered as two most effective strategies to sorb and retain these PFASs from aqueous solution.

Different zeta potential of each sorbent also offers possible explanation for the different sorption capability toward PFASs observed. The poor sorption capability toward these PFASs by sorbent A might be due to its negative zeta potential (Table 1), despite that the fluorine on sorbent A contributes hydrophobic force to interact with PFASs. The negative charge on its surface of the sorbent A might create an electrostatically repulsive force formed between PFASs and sorbent A, leading to poor sorption of these PFASs. The charge repulsive force can also be explained why there were not sorption ability of the unmodified PEGDA, which has a negative zeta potential.

On the other hand, the zeta potential of sorbent B and sorbent C are positive, which can generate electrostatically attractive force between the negatively charged PFASs and positively charged sorbents spontaneously. As a result, the sorbents can removal all PFASs from water under the tested conditions (over 6 hours of incubation) and were particularly effective for PFOA and PFBS removal. These results strongly suggested that electrostatically attractive force is the dominant interaction for capturing PFASs by sorbents B and C.

Sorbent B performed higher surface charge (39.0±1.6 mV) than sorbent C (31.4±0.6 mV) resulting in absorbing higher concentration of PFBA and PFBS. Sorbent C provided additionally hydrophobic interaction to compensate the lower surface charge leading to the similar sorption capacity for PFOS. Overall, sorbent C would prefer to sorb longer chain of PFASs, while sorbent B would prefer to capture negatively-charged and/or shorter chain PFASs. As the structure of GenX is similar to PFOA, it was not surprising to observe comparable PFAS removal and sorption capacity of GenX by sorbent B and sorbent C.

Characterization of Spent Sorbents

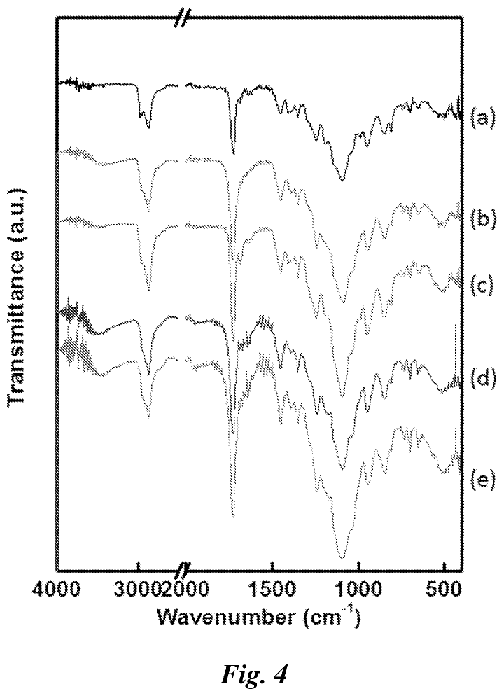

The FTIR spectra of spent sorbents were compared to those of freshly synthesized sorbents (FIGS. 4-6 for spent sorbents A-C, respectively). The peak deconvolution for sorbents before and after absorbing PFASs are shown in FIGS. 7-10.

As sorbent A showed poor sorption ability toward PFASs, only subtle changes in the FTIR spectra of spent sorbent A was observed (FIG. 4). For example, a broad peak in the range from 3600-3000 cm⁻¹ was noted in spectra 4b (FIG. 4b), indicating the ν(O—H) of PFOA. The peak at the range 1300 to 1000 cm⁻¹ could be deconvoluted as 1241, 1189, and 1143 cm⁻¹ contributed from 13FOMA, whereas the peak of νₛ(CF₂) at 1189 cm⁻¹ became a broader peak in the range from 1205 to 1170 cm⁻¹ resulting in the sorption of PFOA. However, as the amount of PFOA sorbed on the sorbent A was too low, the peak representing the carbonyl group, which is shown at the range from 1700 to 1630 cm⁻¹, was not substantial in the FTIR spectra (FIG. 4b). Similar FTIR spectra was observation for PFOS spent sorbent A (FIG. 4c). In FIG. 7B, the shoulder peak at 1265 cm⁻¹ could be assigned as νₛ(CF₂) contributed from PFOS after capturing on sorbent A. Due to the poor sorption of PFBA and PFBS by sorbent A, the peak for carbonyl group was not clear and not distinguishable in the FTIR spectra (FIGS. 4d and 4e). However, additional peaks were deconvoluted in the range from 1300 to 1000 cm⁻¹ shown in FIGS. 7C and 7D. The peaks at 1201, 1176 and 1132 cm⁻¹ are responding to νₛ(CF₂) of PFBA, whereas the peaks at 1280, 1205, 1172, 1130, and 1103 cm⁻¹ are related with νₛ(CF₂) of PFBS.

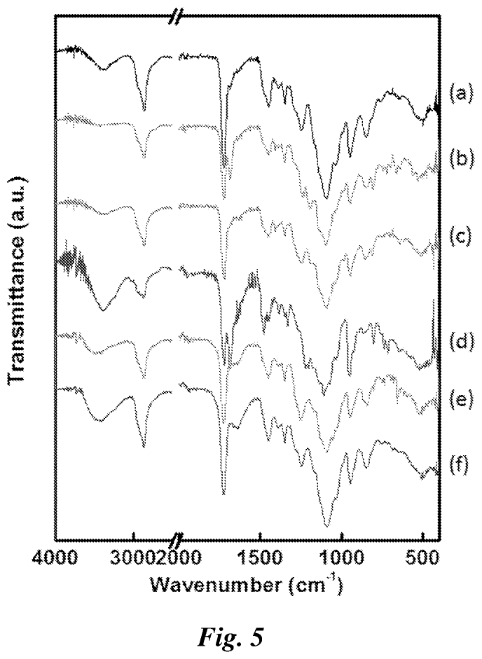

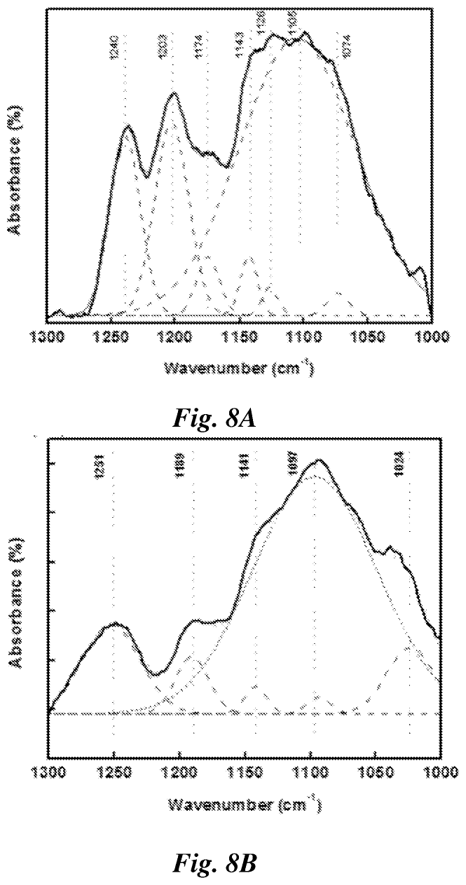

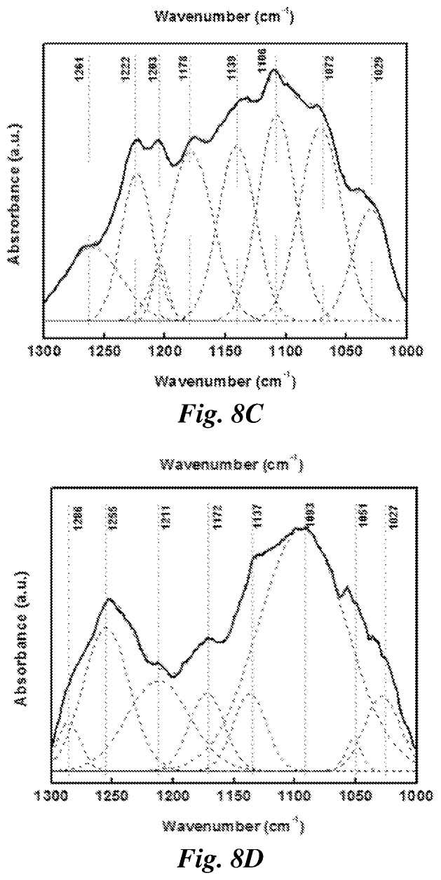

Sorbent B was able to capture PFOA effectively (FIGS. 3A and 3B) and was evident by the stronger intensity of the peaks at 1681 cm⁻¹ and 1240 cm⁻¹ in FTIR spectra (FIGS. 5a and 5b). These two peaks corresponded to νₐₛ(COO⁻) and νₛ(CF₂) indicating the occurrence of PFOA sorption on the sorbent. The intensity of C—F peaks in the range from 750 to 530 cm⁻¹ also increases due to the absorbed PFOA. In the peak deconvolution FIG. 8A, a new peak appeared at 1203 cm⁻¹ and the intensity of the peak at 1240 cm⁻¹ increased, providing additional evidence of occurrence of PFOA sorption by sorbent B. Moreover, the peak at 1141 cm⁻¹ was partially shifted to 1174 cm⁻¹ due to the sorption of PFOA by the quaternary ammonium groups on sorbent B. Compared to the sorption of PFOS by sorbent B, the new peak located at 1189 cm⁻¹ was assumed as νₛ(CF₂) contributed from PFOS (FIG. 8B). The broader peak shown at 1251 cm⁻¹ was also due to sorption of PFOS. The FTIR spectra (FIGS. 5d and 5e) were observed from the sorbent B after sorption of PFBA and PFBS (FIGS. 5d and 5e). Sorption of PFBA on the sorbent B was evident by the presence of peaks at 1689 and 1222 cm⁻¹ in FTIR spectra, corresponding to νₐₛ(COO⁻) and νₛ(CF₂) of PFBA, respectively. In the deconvoluted spectra, the peak at 1106, 1203, and 1222 cm⁻¹, are corresponding to νₛ(CF₂) of PFBA (FIG. 8C). Sorbed PFBS on the sorbent B could be observed in the deconvoluted spectra. (FIG. 8D). The new peaks at 1286 and 1211 cm⁻¹ are corresponding to νₛ(SO) and νₛ(CF₂) of PFBS and the peak at 1141 cm⁻¹ was partially shifted to 1173 cm⁻¹, which is similar as the sorption of PFOA of sorbent B. In addition, the peak for quaternary ammonium captures PFBS shifted from 1240 to 1255 cm⁻¹. It demonstrated quaternary ammonium of sorbent B capture PFASs through electrostatic attractive force.

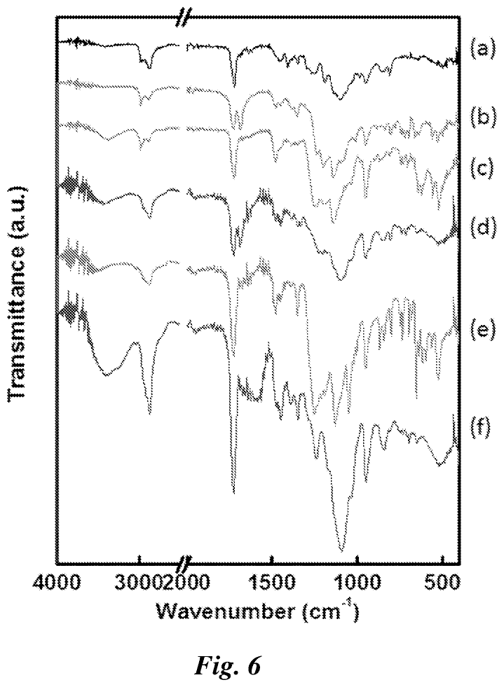

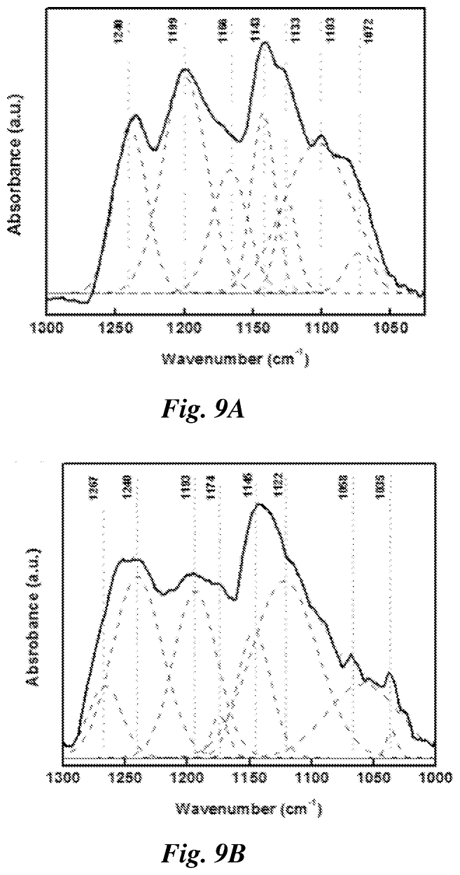

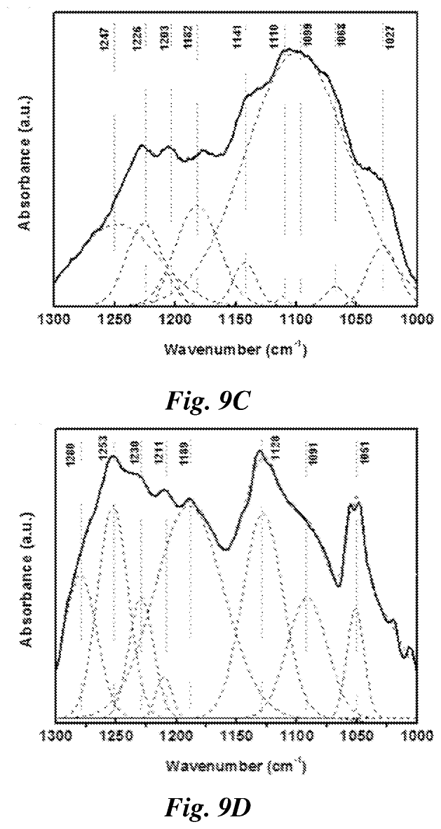

Sorbent C, fluoridation and amination of PEGDA, can provide hydrophobic and electrostatic force simultaneously. FIGS. 6a-6c and FIGS. 9A-9C present the FTIR of sorbent C before and after sorption. The new peak of PFOA at 1234 cm⁻¹ in the presence of sorbent C indicated νₛ(CF₂). The peak at of νₛ(CF₂) was slightly shifted to higher wavenumber, from 1190 to 1199 cm⁻¹, which demonstrated the interaction of C—F between sorbent and PFOA. In addition, the peaks at 1259 cm⁻¹ and 1239 cm⁻¹ was integrated as 1240 cm⁻¹ and the intensity of the peak at 1240 cm⁻¹ was stronger, which is corresponding with the sorption of PFOA. Other peaks showing stronger intensity were detected at the range from 750 to 520 cm⁻¹ because of wagging and rocking vibration of absorbed PFOA. The peaks of νₛ(CN) at 1144 cm⁻¹ was shifted to 1166 cm⁻¹ and the peaks of νₐₛ(COO⁻) at 1459 cm⁻¹ was shifted to 1477 cm⁻¹ demonstrating the interaction between COO groups and CN groups. Compared to the sorption of PFOS in sorbent C, the peak intensity of C—F also increases in the same range as absorbed PFOA. The new peak at 1068 and 1241 cm⁻¹ were corresponding to the νₐₛ(SO₃⁻) from PFOS. Peak deconvolution (FIG. 6d) indicated that the intensity of peaks at 1267 and 1240 cm⁻¹ increased after absorbing PFOS. In addition, the new peak at 1122 cm⁻¹ was also assigned as the νₛ(CF₂) from PFOS. The peak of νₐₛ(SO₃⁻) in the presence of sorbent C was slightly shift to lower wavenumber, from 1201 to 1193 cm⁻¹, whereas the νₛ(SO₃⁻) was also shifted to lower wavenumber, from 1074 to 1058 cm⁻¹ (FIG. 9B). These shifts were assumed that the C—N⁺ in the presence of Sorbent C can also capture PFOS using electrostatic force. Considering the sorption of PFBA and PFBS using sorbent C, similar spectra can be seen, FIGS. 6d and 6e, as PFOA and PFOS. The carbonyl groups and C—F are obviously shown at 1683 and 1226 cm⁻¹, respectively. In the peak deconvolution, the additional peak is shown at 1226 and 1110 cm⁻¹ for absorbed PFBA (FIG. 9C). The peak of quaternary ammonium of MTAC and the fluoride of 13FOMA shifted from 1144 to 1182 cm⁻¹ and 1190 to 1203 cm⁻¹, respectively. In addition, absorbed PFBS on sorbent can be observed on FTIR spectra. The additional peak is shown at 1051 and 1128 cm⁻¹, which is corresponding to νₐₛ(SO₃⁻) and C—F of PFBS. The peak of quaternary ammonium of MTAC and the fluorine of 13FOMA shifted from 1141 to 1189 cm⁻¹, 1190 to 1211 cm⁻¹, and 1259 to 1280 cm⁻¹ (FIG. 9D).

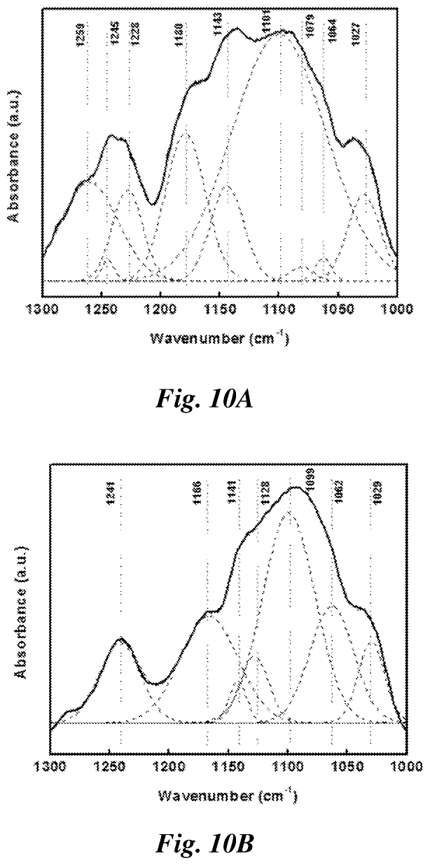

Sorbed GenX on sorbent B and sorbent C was observed on the FTIR spectra. As shown in FIGS. 5f and 6f, the additional peak was observed at 1635 cm⁻¹ and at the range from 1570 to 1683 cm⁻¹. In the peak deconvolution (FIGS. 10A and 10B), the additional peak of absorbed GenX on sorbent B is presented at 1101 and 1228 cm⁻¹ for νₛ(CF₂). The peak at 1259 cm⁻¹ indicates the interaction between quaternary ammonium and carboxylic acid. Additionally, new peak of absorbed GenX on sorbent C illustrates νₛ(CF₂) at 1128 cm⁻¹ and the peak at 1166 cm⁻¹ demonstrates the interaction between quaternary ammonium and carboxylic acid.

PFAS Desorption from Spent Sorbents

The ability to desorb PFASs from the spent sorbents is a favorable feature because the spent sorbent can be regenerated for reuse and thus reduce the overall treatment costs for PFASs. As described herein, different desorption solutions were tested for regeneration of the spent sorbents. Each desorption percentage, calculated by the amount of PFAS released into the extraction solution by the amount of PFAS in the spent sorbent, is shown in Table 4.

TABLE 4
Desorption percentage (%) of Sorbents A, B, and C for PFOA, PFBA,
PFOS, PFBS and Gen X: (a) Sorbent A with 100% methanol as an extraction solvent;
(b) Sorbent A with 100 % acetonitrile as an extraction solvent; and (c) Sorbent
A, B, and C with 70 % methanol with 1 % NaCl as an extraction solvent.

| | | | | |
|---|---|---|---|---|
| PFOA | PFOS | PFBA | PFBS | Gen X |

(a)

| | | | | | |
|---|---|---|---|---|---|
| Sorbent A | 5.3 ± 1.2 | 107.8 ± 11.6 | ND | ND | ND |

(b)

| | | | | | |
|---|---|---|---|---|---|
| Sorbent A | 0 | ND | ND | ND | ND |

(c)

| | | | | | |
|---|---|---|---|---|---|
| Sorbent A | 120.8 ± 26.5 | ND | 72.1 ± 36.1 | 0 | ND |
| Sorbent B | 126.4 ± 19.3 | 97.6 ± 11.9 | 111.6 ± 1.9 | 102.0 ± 0.6 | 84.3 ± 0.2 |
| Sorbent C | 120.8 ± 0.4 | 135.1 ± 0.5 | 130.5 ± 6.9 | 99.2 ± 1.8 | 70.9 ± 5.3 |

PFOA absorbed on sorbent A cannot be extracted well and released only 5% using 100% methanol, or 100% acetonitrile as extraction solution. In contrast, PFOS absorbed on sorbent A can be extracted and released over 100% by treating with 100% methanol. Also, 70% methanol with 1% NaCl was effective for extracting PFOA and PFBA from the spent sorbent A over 121% and 72%, respectively. More than 90% of PFASs on the spent sorbent B and sorbent C can be extracted with 70% methanol containing 1% NaCl. The good extraction efficacy shown by this extraction solution might be due to the alteration of the ionic strength that led to breakage of the electrostatic interaction between PFASs and the sorbents. Using the same extraction solution, approximately 84% and 70% GenX can be released from sorbent B and sorbent C, respectively.

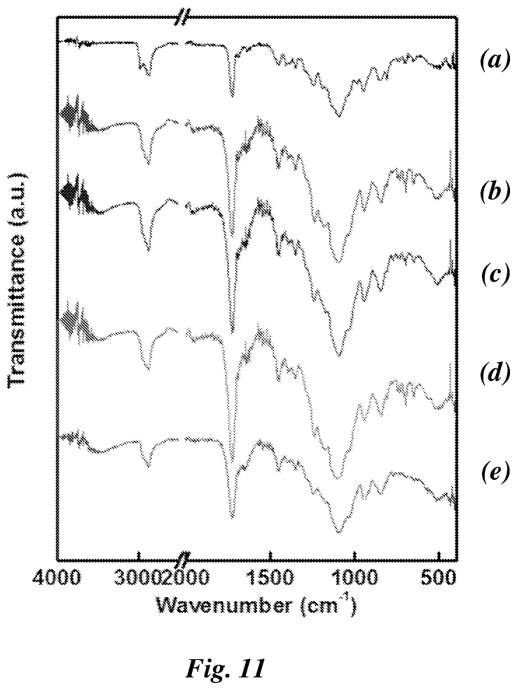

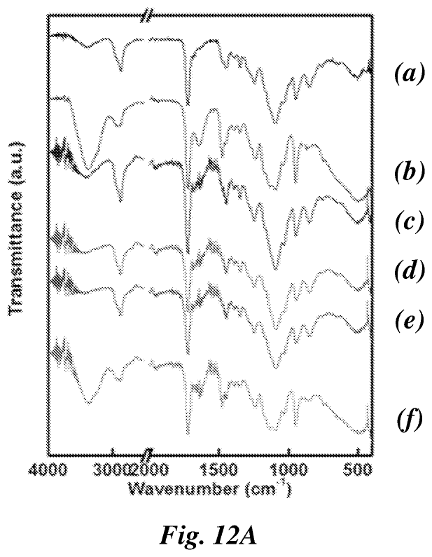

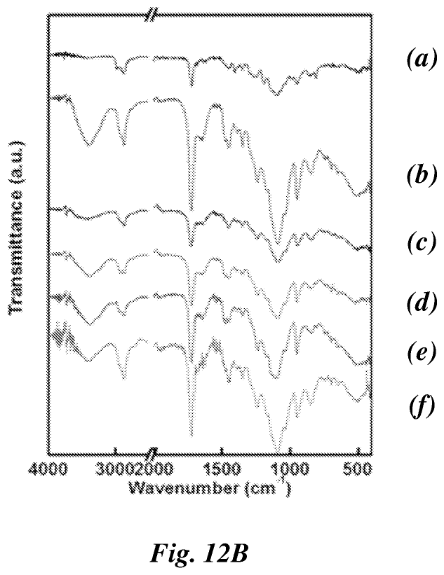

The regenerated sorbents were further characterized based on FTIR analysis (FIGS. 11, 12A, and 12B). The FTIR spectra of the regenerated sorbent A to that of the synthesized sorbent A were similar (FIG. 11). On the other hand, the desorption of PFASs from sorbent B and sorbent C could be recognized in FTIR spectra (FIGS. 12A and 12B). Specifically, the intensity of carboxyl group (1681 cm⁻¹) decreases and even disappears, suggesting that part of absorbed PFOA and PFBA was extracted and released by methanol. Similarly, the releasing of absorbed PFOS and PFBS was observed in the peak deconvolution. The intensity of νₛ(CF₂) of PFOS and PFBS also decreases and even eliminates after desorption. As only 70-84% of sorbed GenX was desorbed from the spent sorbent B and sorbent C, the characterized peak of GenX was observed in the FTIR spectra of the regenerated sorbents B and C. Overall, the results of FTIR analysis of the regenerated sorbents were consistent to the results of desorption of PFASs from the spent sorbents, suggesting that spent sorbent B and C can be regenerated for reuse.

Sorbent Advantages

The present invention provides reusable sorbents with high sorption capacity for long- and short-chain PFAAs and GenX. The new hydrogel-based sorbents were synthesized by functionalizing PEGDA to create both electrostatic attractive force (MTAC) and hydrophobic interaction (13FOMA) for PFAS sorption. Moreover, hydrogel provides higher water content and porous three-dimensional structure network so that the diffusion resistance could be reduced. As a result, the sorption and diffusion model would be different from those used for activated carbons.

Introducing fluorographene (FG) into sorbents in order to create strong hydrophobic regions in the sorbent has enabled high PFOA and PFOS removal (92-97%) at a short equilibrium time of 2 minutes. As described herein, 13FORMA was introduced into sorbent A and C to create hydrophobic regions in the sorbents. Thus, a rapid removal of PFASs at a short equilibrium time is expected. The present invention provides hydrogel-based sorbents to effectively remove short chain of PFASs. Most commercial resins, like Purolite A600E and Purolite A520E, have better sorption capacities for PFOA and PFOS, compared to those by the sorbents of the invention. However, these two resins have much lower sorption capacities for PFBA and PFBS than those of the present invention. For resin A600E, the sorption capacities for PFBA and PFBS were 10 and 3 μmol g sorbent⁻¹, respectively. For resin A520E, the sorption capacities for PFBA and PFBS were 20 and 8 μmol g sorbent⁻¹, respectively. The sorbents showed 8- to 63-fold higher sorption capacities than these commercial resin for shorter chain PFASs. Accordingly, these hydrogel-based sorbents have a potential to remove these concerned shorter chain PFASs from water. Increasing environmental occurrences of GenX and short-chain PFAS have been reported in America, Europe, and China. Similar to long-chain PFASs, GenX and short-chain PFASs have been detected in food and fish and suggested that they are bioaccumulative.

Electrostatically attractive force appeared to be the dominant interaction for sorbing PFASs on to the functionalized PEGDA sorbents. This finding implicates that one can improve the sorption capacity for PFAS, particularly soluble anionic PFASs, by increasing the zeta potential of functionalized PEGDA sorbents. The zeta potential of unmodified PEGDA is negative, while MTAC modified PEGDA shifts the zeta potential from negative to positive. Therefore, manufacturing higher zeta potential of functionalized PEGDA can be achieved by changing the concentration of precursors, MTAC, during synthesis. At low pH, higher sorption capabilities of PFOA and PFOS have been observed. On the other hand, presence of ions such as Na⁺ and Ca²⁺ have shown to interfere the absorption of PFASs. The MTAC modified PEGDA can be also extended to remove metallic anion, like chromium ion from water. Furthermore, PEGDA can be functionalized to be more negatively charged by using sulfonic or carboxyl groups to capture or chelate cationic PFASs. Hydrophobic interaction is another mechanism for sorbing PFASs. However, less sorption capacities of PFASs were observed for sorbent A than those for sorbents B and C. It is possible that more 13FOMA is needed to bond with PEGDA to generate a strong hydrophobic interaction in the sorbent for PFAS removal.

Thermal regeneration is commonly used for regeneration of spent activated carbons and ceramic oxides. However, this method is costly, and unable to regenerate the sorbents to its original sorption capacity. The extraction solution (methanol with NaCl) to regenerate the functionalized PEGDA will be less expensive than thermal regeneration.

### Materials and Methods

Materials. Poly(ethylene glycol) diacrylate (PEGDA, average molecular weight of the polymer=575 g/mole), 2,2-dimethoxy-2-phenylacetophenone (C₆H₅COC(OCH₃)₂C₆H₅, >99%), 1-vinyl-2-pyrrolidinone (C₆H₉NO, >99%), [2-(methacryloyloxy)ethyl]trimethylammonium chloride solution (MTAC, 75% in water), 1H,1H,2H,2H-perfluorooctyl methacrylate (13FOMA, >97%), and PFBA were obtained from Sigma Aldrich (St. Louis, Mo.). PFOA was purchased from Alfa Aesar (Ward Hill, Mass.). PFOS and PFBS were purchased from TCI America (Portland, Oreg.). 2,3,3,3-Tetrafluoro-2-(heptafluoropropoxy)propanoic acid (GenX) was purchased from SynQuest laboratories (Alachua, Fla.).

### Synthesis of Sorbents: Fluoridation, Amination, and Bifunctionalization of PEGDA

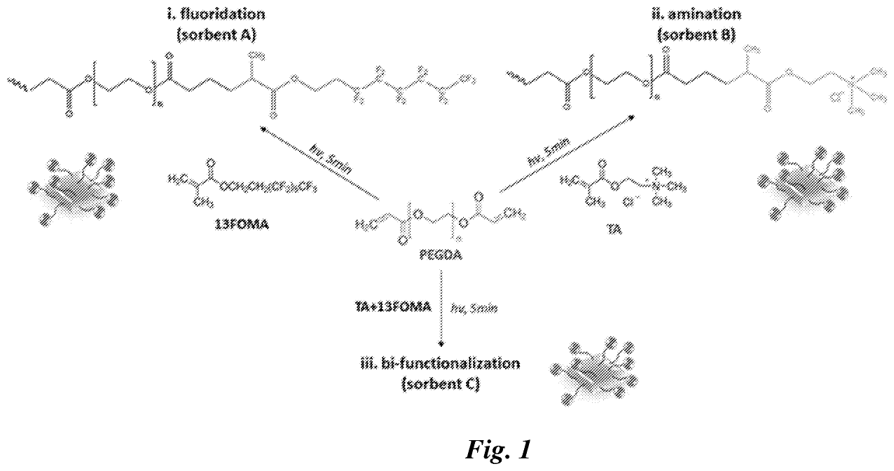

Three different hydrogel sorbents were synthesized by fluoridation, amination, and bifunctionalization of PEGDA (FIG. 1). The fluoridated, aminated, and bifunctionalized PEGDA are described herein as sorbent A, B, and C, respectively. The ratio of PEGDA to the modification reagent, such as 13FOMA or MTAC is 1, as one acrylate group of PEGDA is to conjugate with the modification reagent and the other acrylate group is for crosslinking. The precursor solution for fluoridation of PEGDA was prepared by adding 266 μL of PEGDA and 173 μL of 1H,1H,2H,2H-perfluorooctyl methacrylate (13FOMA) into 200 μL isopropanol, resulting in final moles of 0.52 mmol PEGDA and 0.52 mmol of 13FOMA. The precursor solution for aminated PEGDA was prepared by adding 266 μL of PEGDA and 130 μL of [2-(methacryloyloxy)ethyl] trimethyl ammonium chloride (MTAC) into 200 μL DI water, resulting in final moles of 0.52 mmol PEGDA and 0.26 mmol of MTAC. The precursor solution for bifunctionalization of PEGDA was prepared by adding 532 μL of PEGDA, 346 μL of 13FOMA, and 260 μL of MTAC into 400 μL isopropanol, resulting in final moles of 1.04 mmol PEGDA, 1.04 mmol of 13FOMA, and 1.04 mmol of MTAC. Each of the precursor solution was then mixed with 3% 2,2-dimethoxy-2-phenylacetophenone. The mixture was filled into a PDMS mold for sorbent synthesis through soft lithography as described previously (Samarasinghe, S. A.; Shao, Y.; Huang, P. J.; Pishko, M.; Chu, K. H.; Kameoka, J., Fabrication of Bacteria Environment Cubes with Dry Lift-Off Fabrication Process for Enhanced Nitrification. PLoS One 2016, 11, (11), e0165839) and as follows. Briefly, the precursor solutions were poured into the wells of PDMS mold and allowed for solidification under 365 nm UV light (80 W) for 5 min. After solidification, these functionalized PEGDA were released from PDMS mold and were washed by DI water three times. These sorbents were stored in oven at 60° C. for experimental use. All sorbents were synthesized in duplicate and the size of the sorbents was 1 mm×1 mm×0.3 mm.

PFAS Sorption and Desorption Tests

The sorbents were used for PFASs sorption/desorption experiments. Five model PFASs: PFOA, PFBA, PFOS, PFB and GenX, were used. PFOA and PFOS were chosen to represent long-chain PFASs, while PFBA and PFBS were chosen to represent short-chain PFAAs. GenX was chosen to represent perfluoroether carboxylic acids (PFECAs). The experiments were carried out in 20 mL glass vials containing 5 mL of each of target PFASs in DI water with 10 mg of each of sorbents (sorbent A, sorbent B, or sorbent C). The vials were capped with polypropylene caps. To determine the sorption capacity of each PFASs by the sorbents, high initial concentrations of PFASs (about 100 mg L⁻¹, except PFOS), were used. The vials were incubated at room temperature with shaking at 150 rpm for 12 hours. During the sorption experiments, liquid samples were collected at 6 and 12 hours. Collected liquid samples were analyzed for PFASs.

Following the sorption experiment (i.e., after 12 hours of incubation), desorption experiments were conducted in 20 mL glass vials using a range of different extraction solution, including 100% methanol, 100% acetonitrile, or 70% methanol with 1% NaCl. Briefly, the spent sorbents in the vials were washed with DI water twice before adding 5 mL of extraction solution. The mixture was incubated at room temperature with shaking at 150 rpm for 12 hours. The spent sorbents after desorption were washed with DI water two times. Duplicate samples were used in each set of sorption/desorption experiments.

PFAS Analysis

The concentrations of PFOA, PFOS, PFBA, and PFBS in liquid samples were determined using High-Performance Liquid Chromatography (HPLC, UltiMate 3000, Thermo Scientific)/Triple Quadrupole Mass Spectrometer (QqQ-MS, Quantiva, Thermo Scientific) as described previously (Abada, B. S. A. Degradation of poly- and per-fluoroalkyl substances (PFASs) using photocatalyst zinc oxide. Texas A&M University, 2016). Briefly, 10 μL of samples were injected and then separated by a Hypersil Gold Sum 50×3 mm column (Thermo Scientific, Waltham, Mass.) maintained at 30° C. using a solvent gradient method. The flow rate was 0.5 μL min⁻¹. Chromatographic separation was achieved on a Solvent A, water (0.1% formic acid) and Solvent B, acetonitrile (0.1% formic acid). The separation gradient method used was 0-4 min (20% B to 80% B), 4-4.1 min (80% B to 95% B), 4.1-6 min (95% B), 6-6.5 min (95% B to 20% B), and 6.5-8 min (20% B). MS parameters were optimized for each of these PFAAs under direct infusion at 5 μL/min to identify the SRM (Selected Reaction Monitoring) transitions (precursor/product fragment ion pair). Sample acquisition and analysis were performed with TraceFinder 3.3 (Thermo Scientific).

The concentrations of GenX in liquid samples were analyzed by High-Performance Liquid Chromatography (HPLC, Agilent 1290 Infinity II)/Triple Quadrupole Mass Spectrometer (QqQ-MS, Agilent 6470) equipped with a Jet Stream electrospray ionization (ESI) source. 10 μL of samples were injected and then separated by an Agilent ZORBAX Eclipse Plus C-18 narrow bore (2.1 mm×100 mm, 1.8 μm) HPLC column maintained at 40° C. The flow rate was 0.5 mL min⁻¹. Chromatographic separation was achieved on a Solvent A (5 mM ammonium acetate in water), and Solvent B (95% MeOH and 5% water with 5 mM ammonium acetate). The separation gradient method used was 0-0.5 min (holding at 5% B), 0.6-3 min (5% B to 95% B), 3.1-4 min (holding at 95% B), 4.1-5 min (95% B to 5% B) and stabilize column at 5% B for 5 min. MS parameters were optimized for GenX under direct infusion at 0.4 mL min⁻¹ to identify the MRM (Multiple SRM) transitions (precursor/product fragment ion pair). Sample acquisition and analysis were performed with MassHunter B.08.02 (Agilent).

Characterization of Sorbents

Fourier transform infrared (FTIR) analysis was used to characterize the sorbents before and after PFAS sorption. All sorbents were dried in a vacuum dryer at 25° C. for hours before the FTIR analysis using a Thermo Nicolet 380 FTIR spectrometer in the Materials Characterization Facility at Texas A&M University. The wavenumber ranges from 400 to 4000 cm⁻¹ was used and the absorbance was recorded with 0.9 cm⁻¹ resolution. The peak deconvolution was analyzed using software Origin® in the range from 1000 to 1300 cm⁻¹. The zeta potential of the synthesized sorbents and the pure PEGDA were measured using a Zetasizer Nano ZS90 (Malvern, UK) in the Biomedical Engineering Facility at Texas A&M University.

While illustrative embodiments have been illustrated and described, it will be appreciated that various changes can be made therein without departing from the spirit and scope of the invention.

1. A sorbent for removing a perfluoroalkyl substance or a polyfluoroalkyl substance from an aqueous source, comprising a hydrogel having poly(ethylene oxide) repeating units and multiple perfluoroalkyl groups or polyfluoroalkyl groups and multiple amine groups.

2. A sorbent for removing a perfluoroalkyl substance or a polyfluoroalkyl substance from an aqueous source, comprising a hydrogel having poly(ethylene oxide) repeating units and multiple amine groups.

3. A sorbent for removing a perfluoroalkyl substance or a polyfluoroalkyl substance from an environment, comprising a hydrogel having poly(ethylene oxide) repeating units and multiple perfluoroalkyl groups or polyfluoroalkyl groups.

4. The sorbent of claim 1, wherein the ratio of poly(ethylene oxide) groups to perfluoroalkyl or polyfluoroalkyl groups to amine groups is from about 1:0.5:0.5 to about 1:0.5:2.

5. The sorbent of claim 2, wherein the ratio of poly(ethylene oxide) groups to amine groups is from about 1:0.5 to about 1:2.

6. The sorbent of claim 3, wherein the ratio of poly(ethylene oxide) groups to perfluoroalkyl or polyfluoroalkyl groups is from about 1:0.5 to about 1:3.

7. The sorbent of claim 1, wherein hydrogel is derived from polymerization of a poly(ethylene glycol) diacrylate (PEGDA) and one or more of a polymerizable perfluoroalkyl compound or polyfluoroalkyl compound, and/or a polymerizable amine compound.

8. The sorbent of claim 1, wherein the perfluoro- or polyfluoroalkyl group is a —CₙFₙ₊ CF group, wherein n is an integer from =3 to 11.

9. The sorbent of claim 1, wherein the amine group is a quaternary amine group.

10. The sorbent of claim 1, wherein the amine group is a —N(CH₃)₃⁺ group.

11. The sorbent of claim 1 further comprising an additive to enhance the hydrophobicity of the hydrogel.

12. The sorbent of claim 1 further comprising fluorographene.

13. The sorbent of claim 1 further comprising an additive to enhance the mechanic strength of the hydrogel.

14. The sorbent of claim 1 further comprising calcium oxide, silica, silicon dioxide, alumina, and aluminum oxide.

15. The sorbent of claim 1, wherein the sorbent is immobilized on a substrate.

16. The sorbent of claim 1, wherein the sorbent is immobilized on a porous substrate.

17. The sorbent of claim 1, wherein the sorbent is a regeneratable sorbent.

18. The sorbent of claim 1, wherein the sorbent is prepared by a dry lift-off process, lithography, or molding.

19. A method for removing a perfluoroalkyl substance or polyfluoroalkyl substance from an environment, comprising contacting an environment contaminated with one or more perfluoroalkyl substances or polyfluoroalkyl substances with a sorbent of claim 1.

20-26. (canceled)

27. A device for removing, collecting, or concentrating a perfluoroalkyl substance or polyfluoroalkyl substance from an environment, the device comprising a sorbent of claim 1, and a housing for receiving the sorbent and adapted to provide contact between the sorbent and the environment.
